(19) United States
(12) Patent Application Publication
(10) Pub. No.: US 2025/0236376 A1
(43) Pub. Date: Jul. 24, 2025

(54) A THRUST GENERATING ASSEMBLY

(71) Applicant: KONGSBERG MARITIME SWEDEN AB, KRISTINEHAMN (SE)

(72) Inventors: Martin MELIN, KARLSTAD (SE); Hekkanen MIKKO

(21) Appl. No.: 18/702,045

(22) PCT Filed: Oct. 18, 2022
(86) PCT No.: PCT/EP2022/078993

§ 371 Date: Apr. 17, 2024

(30) Foreign Application Priority Data
Nov. 9, 2021 (SE) 2151375-9

(51) Int. Cl. B63H 23/32; C23F 13/06; F16C 17/14; F16C 17/24

(52) U.S. Cl. CPC B63H 23/326; C23F 13/06; F16C 17/24; C23F 2213/31; F16C 17/14; F16C 2326/30

(57) ABSTRACT

The invention relates to a thrust generating assembly for a marine vessel, comprising a rotatable device (201) adapted to carry a thrust generating device adapted to generate a thrust by acting on water supporting the marine vessel, —wherein the thrust generating assembly comprises a bearing (211, 212) for the rotatable device (201), —wherein the bearing (211, 212) comprises an envelope (222) adapted to be fixed to a part of the vessel which is stationary in relation to a rotational axis (R) of the rotational device, —wherein the thrust generating assembly comprises a liner (221) which is fixed to the rotatable device (201), —wherein the liner (221) is electrically isolated from the rotatable device (201).

### TECHNICAL FIELD

The invention relates to a thrust generating assembly for a marine vessel, a marine vessel with such a thrust generating assembly, and a method of manufacturing a thrust generating assembly for a marine vessel.

### BACKGROUND

Bearings for rotatable devices, such as propeller shafts, adapted to carry marine vessel thrust generating devices, such as propellers, are known in many forms. U.S. Pat. No. 3,177,841 and DE3030141A1 give examples. There is a desire to avoid excessive wear of such bearings, which wear may cause early malfunctions of the bearings.

### SUMMARY

It is an object of the invention to reduce wear of bearings for rotatable devices adapted to carry marine vessel thrust generating devices.

This object is achieved with a thrust generating assembly for a marine vessel,
comprising a rotatable device adapted to carry a thrust generating device adapted to generate a thrust by acting on water supporting the marine vessel,
wherein the thrust generating assembly comprises a bearing for the rotatable device,
wherein the bearing comprises an envelope adapted to be fixed to a part of the vessel which is stationary in relation to a rotational axis of the rotational device,
wherein the bearing comprises a liner which is fixed to the rotatable device,
wherein the liner is electrically isolated from the rotatable device.

The rotatable device may be electrically conductive. The rotatable device may be made in a metal material. The rotatable device may be made of metal. The metal material of the rotatable device may be for example stainless steel, bronze, a bronze alloy, or a so called Inconel.

The thrust generating device may be provided for the propulsion of the vessel. Alternatively, or in addition, the thrust generating device may be provided for controlling the steering of the vessel, e.g. as a part of a bow thruster.

The liner may be electrically conductive. The liner may be made in a metal material. The liner may be made of metal.

The liner may be cylindrical. The liner may be coaxial with the rotating device. The liner may be fixed externally of the rotatable device. The liner may surround the rotating device. The liner may be fixed to the rotating device by shrink fitting. In some embodiments the liner is fixed to the rotatable device in some other way, e.g. by an adhesive.

The liner and the envelope form parts of the bearing.

The envelope is adapted to be fixed to a part of the vessel which is stationary in relation to a rotational axis of the rotational device. This part may be e.g. a hull of the vessel, a bracket or a strut which is fixed to the hull, or a casing of a rotatable thruster mounted to the vessel. Thus, the envelope may be non-rotating.

The envelope may be made in a plastic material, which may, or may not, be reinforced, e.g. by fibers. For example, the envelope may be made in a fiber-reinforced epoxy. In some embodiments, the envelope is made in rubber or in wood.

The envelope and the liner may be at least partly cylindrical. The envelope may surround the liner. Thereby, the envelope may also surround the rotational device. Thereby, the bearing may be a radial bearing. Alternatively, the bearing may be an axial bearing. Thereby, the liner and the envelope may be distributed axially in relation to the rotational axis of the rotational device.

The liner may be arranged to be exposed to the water supporting the vessel. The water supporting the vessel may be referred to as an outboard water body. The rotatable device may be partly coated, such as with a plastic coating, to avoid exposure to the water, e.g. sea, supporting the vessel.

The invention is based on the realization that excessive wear of a bearing, for a rotatable device adapted to carry a marine vessel thrust generating device, may be caused by marine deposits on the bearing, which deposits are in turn caused by electric currents in the water supporting the vessel. The marine deposits may be formed by lime deposits or calcareous coating.

For example, the vessel may be provided with an active cathodic anti-corrosion system, such as an ICCP (Impressed Current Cathodic Protection) system. Further, the rotatable device may be electrically grounded. The grounding of the rotatable device may be inboard of the hull, e.g. by a slip ring. The grounding may provide for the active cathodic anti-corrosion system to protect the propeller, e.g. the blades and/or a hub thereof.

Without the electrical isolation of the liner from the rotatable device, marine deposits may form on the liner of the bearing. Such deposits may be caused, or stimulated, by the active cathodic anti-corrosion system. Deposition on the liner may also be dependent on structures of a quay at which the vessel is docked. Also, electric shore power may influence such deposition.

More specifically, where the liner is arranged to be exposed to the water supporting the vessel, and the rotatable device is electrically grounded, without the electrical isolation of the liner from the rotatable device, electric currents from the active cathodic anti-corrosion system may travel from the water, through the liner, and to the rotatable device. However, since according to the invention, the liner is electrically isolated from the rotatable device, such an electric current travel through the liner is avoided. Thereby, marine deposit on the liner caused by such electric currents is reduced or eliminated. Thereby, excessive wear of the envelope, caused by such marine deposit, may be avoided. Thereby, an early malfunction of the bearing may be avoided.

The liner may be made in bronze, a bronze alloy, a stainless steel, a copper alloy, titanium, or any other non-corrosive metal or metal alloy. Thereby, the liner may be protected from corrosion, due to the corrosion resistance of the material, even if it is, due to the electric isolation from the rotational device, not protected by an active anti-corrosion system as exemplified above. Also, a metal material of the liner allows fitting the liner to the rotatable part by a shrink fit, as exemplified above. Also, a metal material of the liner provides a hard surface which is suitable for a bearing for the rotatable device, in particular where the envelope is made in a softer material, such as a plastic material as exemplified below. However, in some embodiments, the liner is made of graphite.

Preferably, the liner is electrically isolated from any part having metallic contact with the rotating device. More generally, the liner is preferably electrically isolated from any metallic part.

The rotatable device may be a propeller shaft. Thereby, the thrust generating device may be a propeller. The shaft may extend from a power providing device, such as an engine, or an electric motor, through the structure of a hull or propulsion pod of the vessel, to the propeller.

In some embodiments, the rotatable device may be a rotor on a thruster, which may be adapted to be rotatably mounted to the vessel, in order to allow adjustments of the direction of the thrust provided by the thruster.

In some embodiments, the rotatable device may be a rudder stock of a rudder of the vessel. Thereby, the bearing may be a bearing for the rudder.

In some embodiments, the bearing is a water-lubricated bearing. Thereby, the bearing may be adapted to provide a water film between the envelope and the liner. The water film may be for example equal to or greater than 3 micrometers thick and equal to or less than 20 micrometers thick. Preferably the water film is equal to or greater than 6 micrometers thick and equal to or less than 10 micrometers thick.

In some embodiments, where the rotatable device is a propeller shaft, the bearing is provided in a bridging structure, arranged to hold the shaft at a distance from the vessel hull. The bridging structure may comprise one or more legs connecting the bearing with the hull. Thereby, where the bearing is a water-lubricated bearing, the water film may be provided directly from the surrounding water.

Thus, in a water-lubricated bearing the liner may be arranged to be exposed to the water supporting the vessel, via the water introduced between the liner and the envelope. Thereby, without the electrical isolation of the liner from the rotatable device, electric currents from an active cathodic anti-corrosion system may travel from the water, through the liner, and to the rotatable device. Nevertheless, as suggested, since according to the invention, the liner is electrically isolated from the rotatable device, such an electric current travel through the liner is avoided. Thereby, marine deposit on the liner caused by such electric currents is reduced or eliminated, whereby excessive wear of the envelope, caused by such marine deposit, may be avoided.

In some embodiments, the bearing is a friction bearing. Thereby, the distance between the liner and the envelope may be substantially zero.

In some embodiments, where the rotatable device is a propeller shaft, the bearing is provided in a stern tube, which is adapted to be fixed to, and extend through, a hull of the vessel. The stern tube may thereby form a housing for the bearing. The envelope and the liner may then be positioned in an annular cylindrical space between the rotatable device and the stern tube.

In some embodiments, two bearings, preferably each as exemplified above, may be positioned at, or close to, respective ends of the stern tube. Thereby, one of the bearings may be closer to the vessel bow than the other bearing. Thus, one of the bearings is forward of the other one, as seen in the direction of straight forward travel of the vessel. The bearings may be spaced apart with a space between them in the stern tube through which the propeller shaft extends.

At an inboard end of the stern tube, a sealing may be provided. Water, from outside of the vessel, may be introduced, preferably after being filtered, between the sealing and the forward bearing. The water may be introduced by pumping. After being passed through the forward bearing, the water flows to the rearward bearing. If there is a space separating the bearings, the propeller shaft may be coated there, such as with a plastic coating, to avoid exposing the surface of it to the water.

Preferably, the electrical isolation of the liner from the rotatable device is provided by an electrically non-conductive layer between the liner and the rotatable device. The layer may be formed by a layer of paint, which may be of any suitable electrically non-conductive composition. In some embodiments, the layer is formed by a two-component epoxy paint. In some embodiments, thermal spraying, using a high-temperature jet, is used to provide the layer.

A surface of the liner, for fixing the liner to the rotatable device, may face a radially facing surface of the rotatable device. Alternatively, or in addition, a surface of the liner may face an axially facing surface of the rotatable device, such as a surface of a flange of the rotatable device. Thereby, for the electric isolation of the liner from the rotatable device, an electrically non-conductive layer may be provided between the liner and the axially facing surface of the rotatable device.

According to embodiments of a manufacturing method described below, wherein the liner is fixed to the rotating device by shrink fitting, the layer may be provided to the liner before the liner is fitted to the rotatable device. The layer is preferably adapted to withstand temperatures above 200 degrees Celsius. Thereby, the layer may withstand the heating of the liner needed to perform the shrink fitting.

Alternatively, the layer may be provided to the rotatable device before the liner is fitted to the rotatable device.

The object is also reached with a marine vessel comprising a thrust generating assembly according to any one of the claims therefore, and any embodiment thereof.

The object is also reached with a method of manufacturing a thrust generating assembly for a marine vessel
comprising providing a rotatable device made in a metal material and adapted to carry a thrust generating device adapted to generate a thrust by acting on water supporting the marine vessel,
providing a liner made in a metal material,
applying an electrically non-conductive layer on a surface of the liner,
and subsequently to applying the electrically non-conductive layer, fixing the liner to the rotatable device, so that the surface to which the layer was applied faces the rotatable device.

Thereby, the liner, rather than the rotatable device, is provided with the electrically non-conductive layer, before the liner is fixed to the rotatable device. This is advantageous, since the liner may be considerable smaller and lighter than the rotatable device, and therefore easier to handle for the application of the layer.

### DESCRIPTION OF THE DRAWINGS

Below embodiments of the invention will be described with reference to the drawings in which,

FIG. 1 is a partially sectioned side view of a marine vessel, in the form of a cargo ship,

FIG. 2 is a partially sectioned side view of a part of the vessel in FIG. 1,

FIG. 3 is a sectioned side view of details in FIG. 2,

FIG. 4 depicts steps in a method according to an embodiment of the invention,

FIG. 5 is a partially sectioned side view of a part of a vessel according to an alternative embodiment of the invention,

FIG. 6 is a sectioned side view of details in FIG. 5,

FIG. 7 is a sectioned side view similar to the one in FIG. 6, of details of a further embodiment of the invention, and

FIG. 8 is a sectioned side view similar to the one in FIG. 6, of details of another embodiment of the invention.

### DETAILED DESCRIPTION

FIG. 1 shows a marine vessel 1 comprising a hull 101. The vessel presents a bow 102, and a stern 103. A thrust generating assembly comprises a rotatable device, in the form of a propeller shaft 201, made in a metal material. The rotatable device presents a rotational axis R. The rotatable device carries a propeller 202. The rotatable device extends from a power providing device in the form of an engine or motor 203, through a structure of the hull 101, to the propeller 202. The vessel is provided with a rudder 104. The vessel also comprises a superstructure 105.

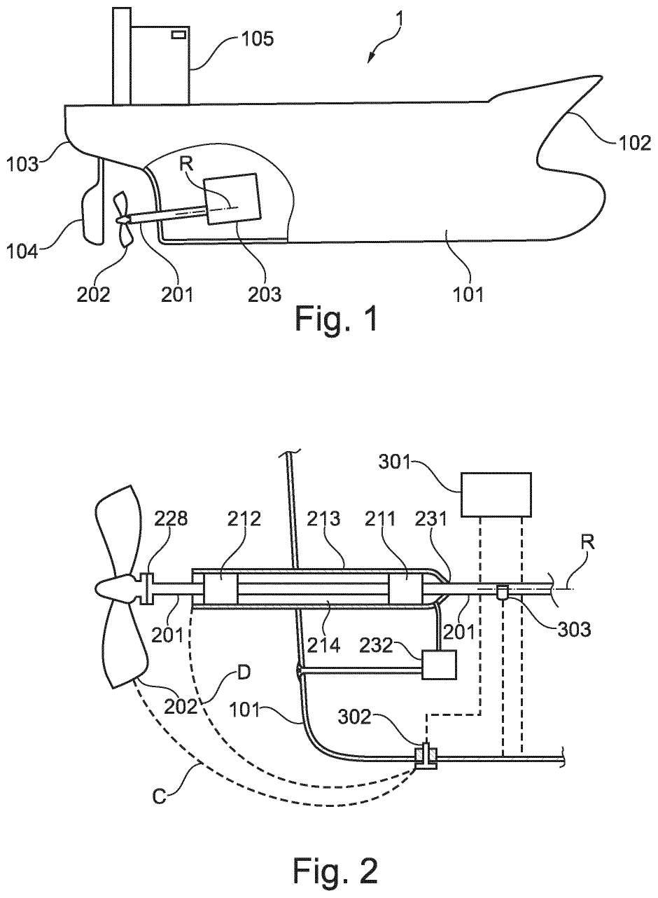

Reference is made also to FIG. 2. The thrust generating assembly comprises two water-lubricated bearings 211, 212 for the rotatable device 201. The bearings are provided in a stern tube 213, which is adapted to be fixed to, and extend through, the hull 101. The bearings 211, 212 are positioned at respective ends of the stern tube. Thereby, one of the bearings 211 is closer to the bow of the vessel than the other bearing 212. The bearings are separated by a space 214 in the stern tube 213 through which the propeller shaft 201 extends. The space 214 is annular.

The vessel is provided with an active cathodic anti-corrosion system, such as an ICCP (Impressed Current Cathodic Protection) system. The active cathodic anti-corrosion system comprises a direct current electric power source 301, which provides a voltage between electric ground, provided e.g. by the vessel hull, and an anode 302. The anode is positioned so as to be exposed to the water supporting the vessel.

The rotatable device 201 is electrically grounded by means of a slip ring 303 connected to electric ground. Parts of the rotatable device 201 that are surrounded by water, have a coating to isolate the rotatable device from the water. Thereby, the active cathodic anti-corrosion system provides an electric circuit, extending through the anode, through the water supporting the vessel (as indicated by the broken line C in FIG. 2), through the propeller 202, and through the rotatable device 201. This circuit serves to protect any damages in the hull coating as well as the propeller 202 from corrosion.

Without any embodiment of the invention, the electric circuit provided by the active cathodic anti-corrosion system would also include a part, as indicated by the broken line D, extending through the water supporting the vessel, from the anode 302 to liners of the bearings 211, 212, which liners are described closer below. As explained herein, such a circuit part D is removed by embodiments of the invention.

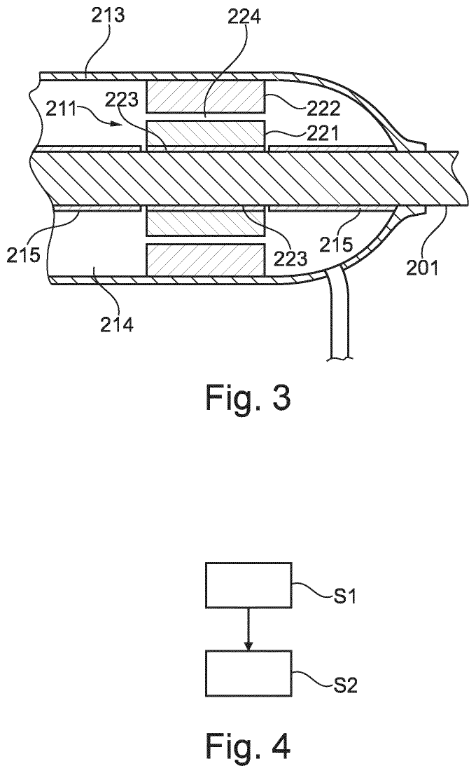

Reference is made also to FIG. 3 which shows in detail the forward bearing 211. The rear bearing 212 is substantially identical in construction. Each bearing 211, 212 comprises a liner 221 which is fixed to the rotatable device 201. Each bearing further comprises an envelope 222 which is fixed to the stern tube 213. The envelope 222 and the liner 221 are cylindrical. The liner surrounds the rotating device. The envelope surrounds the liner. The liner is made in metal. The envelope is made in a plastic material.

During operation of the vessel, each bearing 211, 212 provides a water film in the annular space 224 between the envelope 222 and the liner 221. In FIG. 3, the thickness of this space is exaggerated for this presentation.

As illustrated in FIG. 2, water for the bearings 211, 212 is provided as follows: The inboard end of the stern tube 213 is sealed by a seal 231. Water, from outside of the vessel, is introduced, after being filtered, between the seal 231 and the forward bearing 211. Pumping of the water is provided by a pump arrangement 232. Filtering of the water may also be provided, e.g. by a filter in the pump arrangement 232. After being passed through the annular space 224 of the forward bearing 211, the water flows to the rearward bearing 212. The water is released rearwards of the rearward bearing 212, as illustrated by the arrow A in FIG. 2.

As can be seen in FIG. 3, and as understood from above, in the space 214 separating the bearings 211, 212, the rotatable device 201 is coated with a plastic coating 215, to avoid exposure to the water in the space 214.

As illustrated in FIG. 3, the liner 221 is electrically isolated from the rotatable device 201. The electrical isolation of the liner from the rotatable device is provided by an electrically non-conductive layer 223 between the liner and the rotatable device. Thereby, the liner is removed from the circuit provided by the active cathodic anti-corrosion system or any other external electrical current source. This will reduce or eliminate deposits on the liner, and excessive wear of the envelope 222 is thereby avoided.

In the example in FIG. 2, the propeller 202 is fixed to the rotatable device 201 with a flange connection, comprising a flange 228 on the rotatable device 201.

With reference to FIG. 4, a method of manufacturing the thrust generating assembly described above will be described. The method comprises the following steps: An electrically non-conductive layer is applied S1 on a surface of a liner. The layer may be formed by a layer of paint, e.g. a two component epoxy paint, or by thermal spraying. The liner is fixed S2, by shrink fitting, to a rotatable device, so that the surface to which the layer was applied faces the rotatable device.

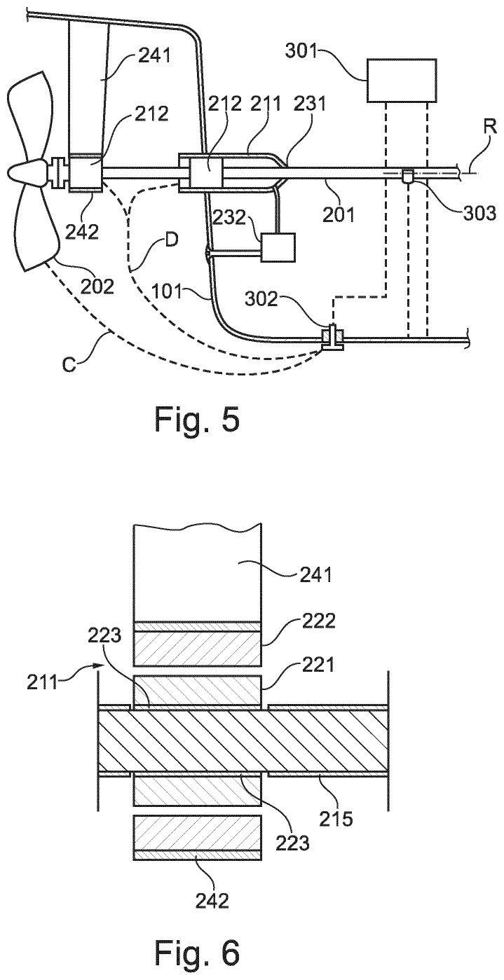

Reference is made to FIG. 5, showing an alternative embodiment of the invention. The embodiment is similar to the one shown in FIG. 2 and FIG. 3, with the following difference: The rearward bearing 212 is provided in a bridging structure 241, arranged to hold the shaft 201 at a distance from the hull 101. The bridging structure comprises two legs forming a V-shape when seen in the longitudinal direction of the vessel. Such a bridging structure may also be referred to as an A-bracket. The legs of the bridging structure 241 connect the rearward bearing 212 with the hull 101. Alternatively, the bridging structure may comprise a single leg.

Reference is made also to FIG. 6. Similarly to what is shown in FIG. 3, the rearward bearing 212 comprises a liner 221 which is fixed to the shaft 201. The rearward bearing 212 comprises an envelope 222 which is fixed to a tube 242 of the bridging structure 241. Thereby, the water film between the liner and the envelope may be provided directly from the surrounding water.

As suggested above, without any embodiment of the invention, the electric circuit provided by the active cathodic anti-corrosion system would also include a part, as indicated by the broken line D in FIG. 5, extending through the water supporting the vessel, from the anode 302 to liners of the bearings 211, 212. As explained herein, such a circuit part D is removed by the liners 221 being electrically isolated from the shaft 201. As indicated in FIG. 6, in each bearing, the electrical isolation of the liner 221 from the shaft is provided by an electrically non-conductive layer 223 between the liner and the shaft. Thereby, the liner is removed from the circuit provided by the active cathodic anti-corrosion system or any other external electrical current source. This will reduce or eliminate deposits on the liner, and excessive wear of the envelope 222 is thereby avoided.

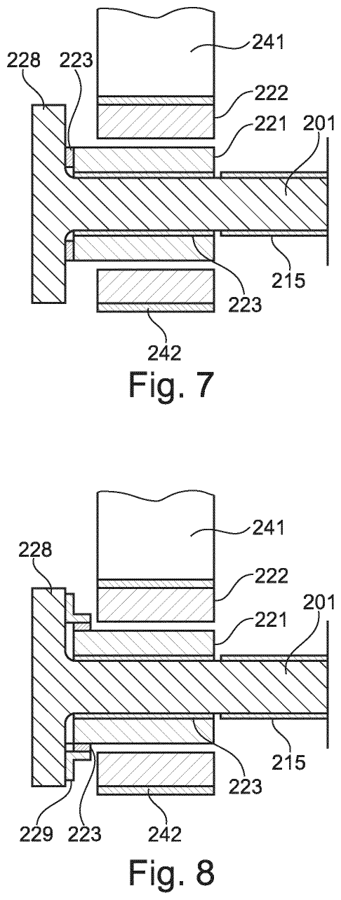

FIG. 7 shows a further embodiment, which is similar to the one shown in FIG. 5 and FIG. 6. Similarly to what is shown in FIG. 2, the rotatable device 201 comprises a flange 228 on the rotatable device 201. It should be noted that in this embodiment, a surface of the liner faces an axially facing surface of the flange of the rotatable device. Thereby, an electrically non-conductive layer 223 is provided between the liner 221 and the flange 228 on the rotatable device.

FIG. 8 shows another embodiment, which is similar to the one shown in FIG. 7, but differs therefrom as follows: A flange ring 229 connects the flange 228 of the rotatable device 201 to the liner 221. Thereby, an electrically non-conductive layer 223 is provided between the liner 221 and the flange ring 229.

1-6. (canceled)

7. A marine vessel comprising an active cathodic anti-corrosion system and a thrust generating assembly, the thrust generating assembly comprising:
a rotatable device adapted to carry a thrust generating device;
the thrust generating device is adapted to generate a thrust by acting on water supporting the marine vessel;
the rotatable device is electrically grounded;
a water-lubricated bearing that allows the rotatable device to rotate about a rotational axis;
the water-lubricated bearing comprises an envelope adapted to be fixed to a part of the vessel which is stationary in relation to the rotational axis of the rotatable device;
the envelope comprises a plastic material;
the water-lubricated bearing comprises a liner which is fixed to the rotatable device; and
the liner is electrically isolated from the rotatable device.

8. The marine vessel according to claim 7, wherein the rotatable device is a propeller shaft.

9. The marine vessel according to claim 7, wherein the liner is fixed to the rotatable device by shrink fitting.

10. The marine vessel according to claim 7, wherein the electrical isolation of the liner from the rotatable device is provided by an electrically non-conductive layer between the liner and the rotatable device.

11. The marine vessel according to claim 10, wherein the electrically non-conductive layer is provided to the liner before the liner is fitted to the rotatable device.

12. The marine vessel according to claim 10, wherein the electrically non-conductive layer is provided to the rotatable device before the liner is fitted to the rotatable device.

13. A method of manufacturing a thrust generating assembly for a marine vessel comprising an active cathodic anti-corrosion system and a thrust generating assembly, the thrust generating assembly comprising:
a rotatable device adapted to carry a thrust generating device;
the thrust generating device is adapted to generate a thrust by acting on water supporting the marine vessel;
the rotatable device is electrically grounded;
a water-lubricated bearing that allows the rotatable device to rotate about a rotational axis;
the water-lubricated bearing comprises an envelope adapted to be fixed to a part of the vessel which is stationary in relation to the rotational axis of the rotatable device;
the envelope comprises a plastic material;
the water-lubricated bearing comprises a liner which is fixed to the rotatable device; and
the liner is electrically isolated from the rotatable device, the method comprising:
providing the rotatable device comprising a metal material;
providing the liner comprising a second metal material;
applying an electrically non-conductive layer on a surface of the liner or on the rotatable device; and
subsequently to applying the electrically non-conductive layer, fixing the liner to the rotatable device by shrink fitting, so that the electrically non-conductive layer is between the liner and the rotatable device.

14. The marine vessel according to claim 13, wherein the electrically non-conductive layer is applied to the liner before the liner is fitted to the rotatable device.

15. The marine vessel according to claim 13, wherein the electrically non-conductive layer is applied to the rotatable device before the liner is fitted to the rotatable device.

16. A method of manufacturing a thrust generating assembly for a marine vessel, comprising:
providing a rotatable device comprising a metal material and adapted to carry a thrust generating device adapted to generate a thrust by acting on water supporting the marine vessel;
providing a liner comprising a second metal material;
applying an electrically non-conductive layer on a surface of the liner; and
subsequently to applying the electrically non-conductive layer, fixing the liner to the rotatable device so that the surface to which the electrically non-conductive layer was applied faces the rotatable device.
